(19) United States
(12) Patent Application Publication
(10) Pub. No.: US 2007/0187965 A1
(43) Pub. Date: Aug. 16, 2007

(54) Vacuum gripper

(75) Inventors: Walter Schaaf, Freudenstadt-Gruental (DE); Volker Moll, Lossburg-Wittendorf (DE); Tobias Stahl, Dornstetten (DE)

Correspondence Address: DREISS, FUHLENDORF, STEIMLE & BECKER, POSTFACH 10 37 62, D-70032 STUTTGART, DE

(73) Assignee: J. Schmalz GmbH, Glatten (DE)

(21) Appl. No.: 11/702,125

(22) Filed: Feb. 5, 2007

(30) Foreign Application Priority Data
Feb. 6, 2006 (DE) 102006005872.0-22

(51) Int. Cl. B25J 15/06

(52) U.S. Cl. 294/64.1

(57) ABSTRACT

The invention concerns a vacuum gripper for suctioning workpieces with an vacuum port, an elastic vacuum element and a vacuum element holder, wherein the vacuum element has a sealing lip on its side facing the workpiece, which delimits the vacuum chamber, and the vacuum chamber is flow-connected to the vacuum port, wherein the vacuum gripper has means that display the suction state.

The application claims Paris Convention priority of DE 10 2006 005 872.0 filed Feb. 6, 2006 the complete disclosure of which is hereby incorporated by reference.

### BACKGROUND OF THE INVENTION

The invention concerns a vacuum gripper for suctioning workpieces, comprising a vacuum port, an elastic vacuum element and a vacuum element holder, wherein the vacuum element has a sealing lip on its side facing the workpiece, which seals a vacuum chamber, and the vacuum chamber is flow-connected to the vacuum port, wherein the vacuum gripper has means for determining or displaying the state of wear disposed on an element subject to wear during use of the vacuum gripper causing the removal of material and disposed in the region of the sealing lip.

Vacuum grippers are used for suctioning objects or workpieces to thereby either fix and/or handle them. When the vacuum grippers are located on manipulators, the suctioned object can be transported. It is thereby important that the object is correctly suctioned and the underpressure in the vacuum chamber is sufficiently high to ensure that the object is reliably held. Vacuum sensors are used to determine the underpressure. They are provided in the vacuum line to the vacuum gripper and pass on the detected value to a machine control which switches off the underpressure source when the desired underpressure has been reached, or blocks off the vacuum line. When the underpressure is not obtained, the vacuum gripper may be faulty or worn, and must be replaced.

DE 1 963 250 A1 discloses a vacuum suction plate for lifting and transporting objects, which seats on the object with a plurality of sealing lips. DE 42 29 208 A1 discloses a device for lifting and transporting loads, the device having a mechanism which issues an alarm when the vacuum below the vacuum plate slowly decreases due to an unacceptably high leakage rate. Further embodiments of vacuum grippers are disclosed in DE 198 17 216 C2 and DE 198 17 323 A1.

It is therefore the underlying purpose of the present invention to design a vacuum gripper of the above-mentioned type which is inexpensive and clearly indicates whether or not it is still fully operative.

### SUMMARY OF THE INVENTION

This object is achieved in accordance with the invention by a vacuum gripper having the elements of the independent claim.

The inventive vacuum gripper permits detection of a faulty vacuum gripper or, in particular, vacuum element, before determining that an underpressure can no longer be obtained, since e.g. the sealing lip fails to tightly seal the vacuum chamber or the suction element has become porous.

The wear limit is detected at an earlier time, since the vacuum gripper has means that indicate its state of wear. For this reason, measures can be taken at an early stage before the vacuum gripper fails, to prevent any malfunction during suctioning of the workpiece, e.g. in consequence of insufficient underpressure. It is particularly advantageous to display the state of wear of the vacuum grippers that are subjected to wear, in particular, to maintain safety in production plants.

The means comprise an element that is worn or abraded during use of the vacuum gripper. The state of wear can be detected or displayed on or via this element that is subjected to wear. This element that is subjected to wear is thereby e.g. subjected to abrasion, wherein the element is advantageously disposed in the area of the sealing lip, i.e. in the area that engages or abuts the workpiece to be suctioned.

In an embodiment, the vacuum element has, at least in sections, an element whose color changes with time or with the number of alternating stress or through application of an underpressure. This color change displays the state, in particular, the state of wear of the vacuum gripper. It may show e.g. the age of the vacuum gripper, whether the vacuum gripper has been frequently or rarely used, or whether or not the desired underpressure is applied to the vacuum gripper to achieve the desired suctioning force.

In a further embodiment, an RFID element is integrated in the vacuum gripper and, in particular, in the vacuum element, which is flow-connected to the vacuum chamber. This permits storing and/or generation of retrievable data that determines e.g. the production date of the vacuum gripper or the obtained underpressure.

Further advantages, features and details of the invention can be extracted from the dependent claims and the following description which shows in detail particularly preferred embodiments with reference to the drawing. The features shown in the drawing and mentioned in the description and the claims may thereby be essential to the invention, either individually or collectively in arbitrary combination.

### BRIEF DESCRIPTION OF THE DRAWING

FIG. 1 shows a cross-section through a vacuum gripper;

FIG. 2 shows a schematic representation of a vacuum gripper with an electrically conducting insert;

FIG. 3 shows a schematic representation of a vacuum gripper with a colored coating;

FIG. 4 shows a schematic representation of a vacuum gripper comprising a material whose color changes,

FIG. 5 shows a schematic representation of a vacuum gripper with wearing elements with different heights;

FIG. 6 shows a schematic representation of a vacuum gripper whose color changes at a certain underpressure;

FIG. 7 shows a schematic representation of a vacuum gripper with an electrically conducting insert that fails after a certain number of load changes;

FIG. 8 shows a schematic representation of a vacuum gripper with a channel and a floater disposed in the channel;

FIG. 9 shows a schematic representation of a vacuum gripper with a channel and a display element disposed on the channel;

FIG. 10 shows a schematic representation of a vacuum gripper with an abrasive electrically conducting elastomeric layer;

FIG. 11 shows a schematic representation of a vacuum gripper with level markings on the sealing lip edge;

FIG. 12 shows a schematic representation of a vacuum gripper with an integrated proximity switch or a light barrier;

FIG. 13 shows a schematic representation of a vacuum gripper with an integrated RFID element; and

FIG. 14 shows a schematic representation of a vacuum gripper with integrated vacuum sensor.

### DESCRIPTION OF THE PREFERRED EMBODIMENT

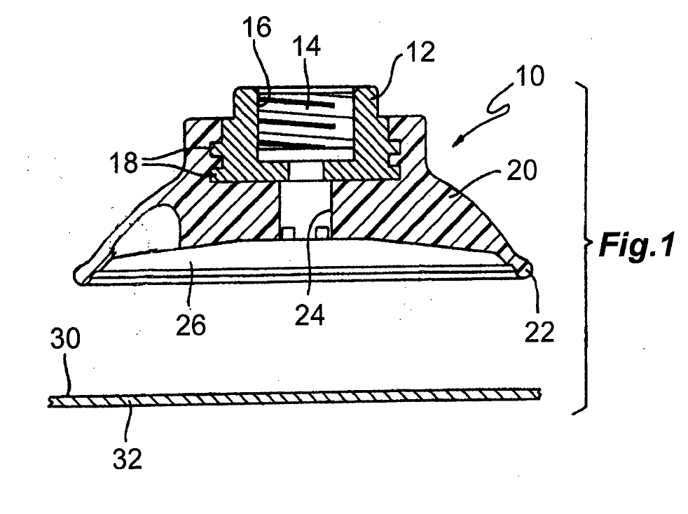

FIG. 1 shows a cross-section through a vacuum gripper that is designated in total with 10. Reference number 12 designates a vacuum element holder. It has a vacuum port 14 with e.g. an inner thread 16. The outer side of the vacuum element holder 12 has two peripheral beads 18 to which an elastic vacuum element 20 is securely fixed. This vacuum element 20 is approximately bell-shaped and has a circumferential lower edge which is formed as a sealing lip 22. The vacuum element 20 also has a central opening 24 which communicates with the vacuum port 14. The opening 24 terminates in a vacuum chamber 26 which is surrounded by the sealing lip 22 which is disposed onto the surface 30 of a workpiece 32.

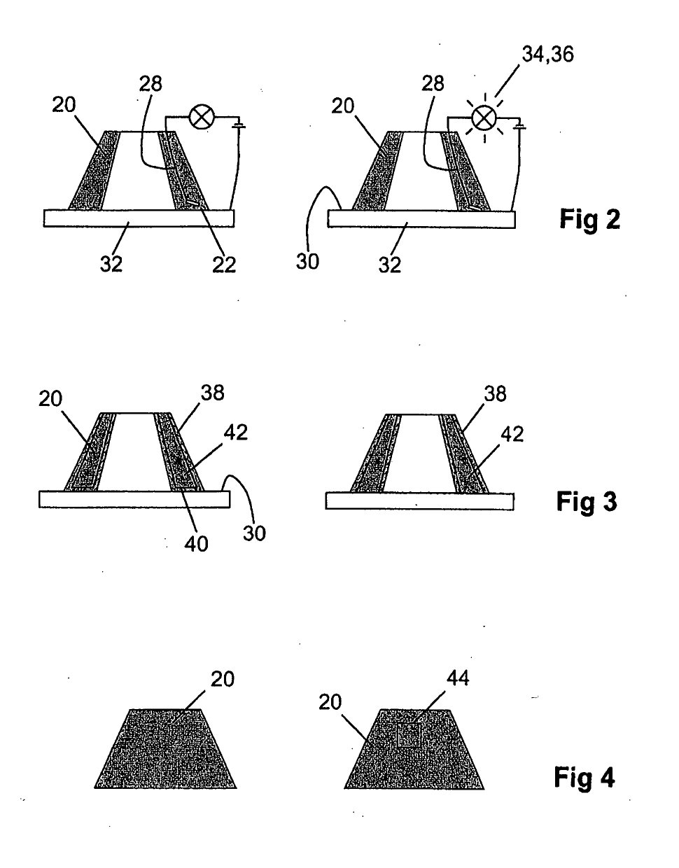

The right-hand sides of FIGS. 2 through 12 each show the worn state of the vacuum gripper 10.

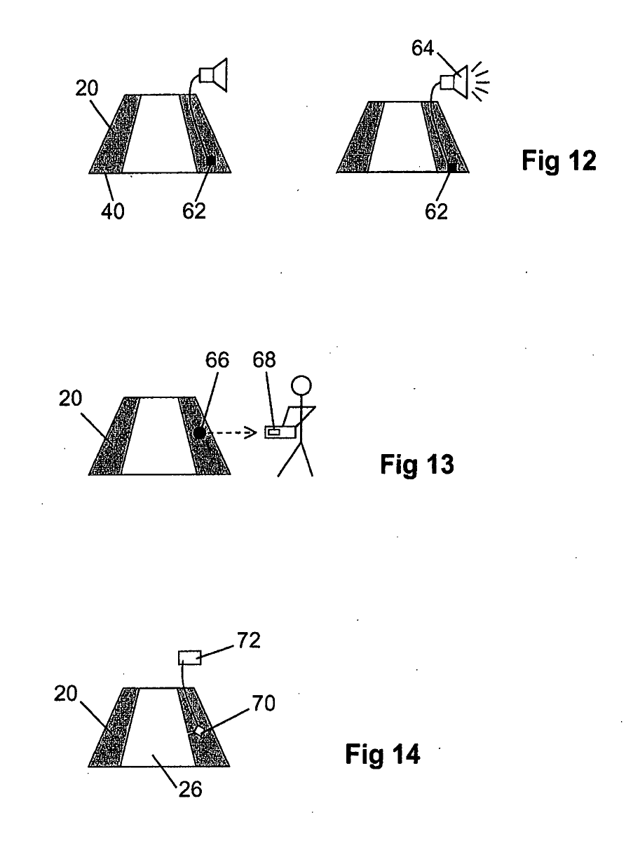

In FIG. 2, wherein a conducting object 28, e.g. a metal gauze or a metallic thread, is cast into the vacuum element 20. This object 28 terminates in the area of the sealing lip 22 which is disposed onto the workpiece 32. When the sealing lip 22 is worn, the free end of the object 28 is exposed and contacts the surface 30 of the workpiece 32 providing electric contact with the workpiece 32 which activates a signal generator 34, e.g. a lamp 36. In this fashion, the wear limit of the vacuum gripper 10 can be displayed when the free end of the object 28 defines this limit. Other displays such as e.g. loudspeakers 64 (FIG. 12) are feasible.

In FIG. 3, the suction element 20 has a colored coating 38 which is gradually worn in the area of the sealing lip 22 which is designed as a wearing element 40 and is supported on the surface 30 of the workpiece 32. When the coating 38 has been completely removed from the supported location, the material 42 below the coating 38 is visible, which has a different color, thereby indicating the wear limit.

FIG. 4 shows an embodiment, in which the vacuum element 20 is produced from a plastic material, whose color changes over time. In this fashion, the age of the vacuum gripper 10 can be displayed irrespective of its use. The vacuum gripper 10 or the vacuum element 20 can also be provided with a sticker 44 whose color changes with time. The color change may e.g. be caused by the influence of oxygen or UV light.

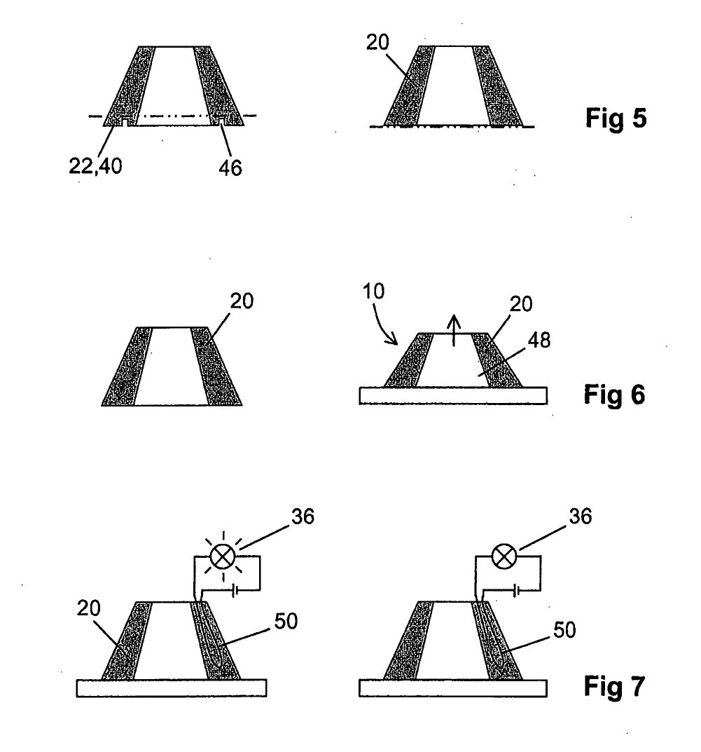

In the embodiment of FIG. 5, the sealing lip 22 or the wearing element 40 is provided with a groove 46 whose depth determines the degree of wear. When the groove 46 is no longer visible, the vacuum element 20 has reached its wear limit.

In FIG. 6, the material of the vacuum element 20 consists of a colored plastic material which changes its color at a certain underpressure. When the vacuum gripper 10 does not reach this underpressure, the color does not change which, in turn, determines that the wear limit has been reached. Reference numeral 48 designates the underpressure in the vacuum gripper 10.

In the embodiment of FIG. 7, an electrically conducting element, in particular, a thread is cast into the elastic vacuum element 20 which breaks after a certain number of load changes. Breaking of the thread 50 indicates that the wear limit has been reached, which may be visually displayed by the lamp 36, whose current supply is interrupted.

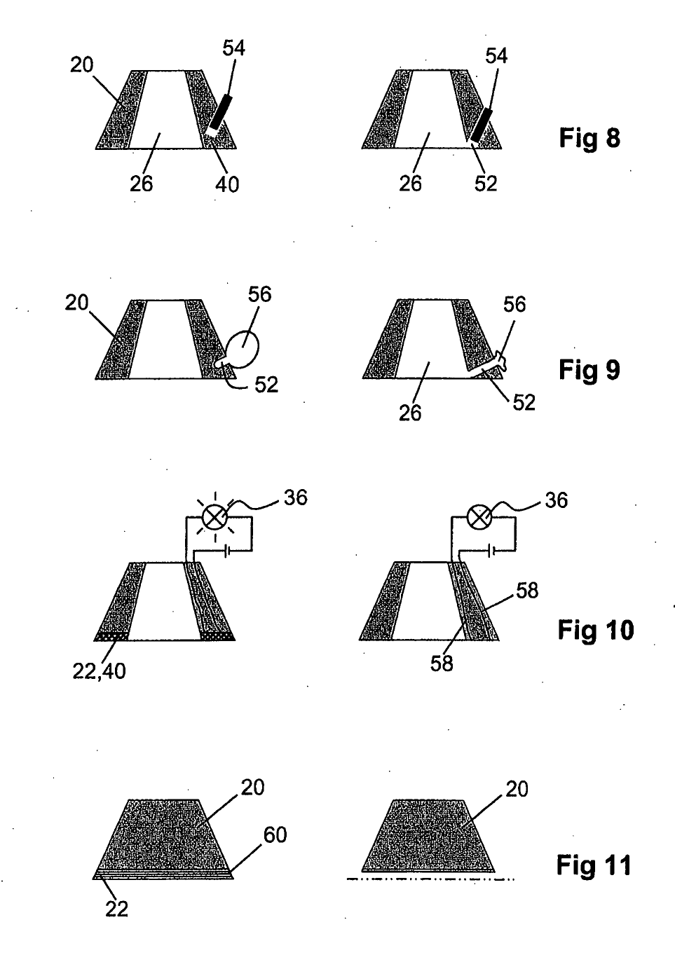

FIG. 8 shows an embodiment, in which the vacuum element 20 is provided with a channel which is closed on its inner side, i.e. in the direction of the vacuum chamber 26. This channel 52 is opened towards the vacuum chamber 26 due to use of the wearing element 40 on the lower side of the vacuum element 20, such that the underpressure that prevails in the vacuum chamber suctions a floater 54. This is visible from the outside in that the floater 54 disappears completely or partially in the vacuum element 20.

In the embodiment of FIG. 9, the vacuum element 20 also has a channel 52 which is initially closed to the inside, and is opened towards the vacuum chamber 26 when the wear limit has been reached. The outer side of the channel 52 terminates in a bubble 56 to which the underpressure that prevails in the vacuum chamber 26 is applied when the wear limit has been reached, such that the bubble 56 collapses. This can also be seen from the outside.

In the embodiment of FIG. 10, the wearing element 40 consists of an electrically conducting elastomeric layer and forms e.g. the sealing lip 22 or part thereof. Two cables 58, to which a lamp 36 is connected, terminate in this wearing element 40. When the wearing element 40 has been worn to such an extent that there is no longer an electric connection between the two cables 58, the current supply to the lamp 36 is interrupted which can also be visually detected.

FIG. 11 shows an embodiment, wherein the vacuum element 20 has level markings 60 on its outer side in the area of the edge of the sealing lip 22. The level markings 60 are also worn through wear of the sealing lip 22. The level markings 60 may thereby be divided into areas, in particular, three areas, such as full function (green), warning (yellow), exchange (red).

FIG. 12 shows an embodiment, wherein a proximity switch 62 or a light barrier are vulcanized into the vacuum element 20. The proximity switch 62 is exposed by wearing off the wearing element 40 and e.g. a warning is triggered via a loudspeaker 64.

FIG. 13 shows an embodiment, wherein an RFID element 66 is embedded in the vacuum body 20 which stores data about the state and product, such as e.g. the production date, and can be read e.g. using a reader 68. In this fashion, the age of the vacuum gripper 10 can be determined from the outside.

In the embodiment of FIG. 14, a vacuum sensor 70 is integrated in the suction element 20, which is connected to the vacuum chamber 26 and connected to an evaluation unit 72. The evaluation unit 72 detects any failure to reach the required underpressure in the vacuum chamber 26, and defines it as the wear limit.

The inventive vacuum gripper 10 determines the wear limit in a simple fashion, and the vacuum gripper 10 can be replaced before the wear limit is reached.

We claim:

1. A vacuum gripper for suctioning a workpiece, the gripper comprising:
a vacuum port;
an elastic vacuum element having a sealing lip on a side facing the workpiece to delimit a vacuum chamber, said vacuum chamber being flow-connected to said vacuum port;
a vacuum element holder disposed between said vacuum element and said vacuum port;
means for detecting or displaying a state of wear, said detecting or displacing means having a wear element that is worn during use of the vacuum gripper through removal of material, said wear element being disposed in an area of said sealing lip; and
an electrically conducting object disposed in said vacuum element, said conducting object being exposed or interrupted by wear of said wear element.

2. The vacuum gripper of claim 1, wherein said conducting object terminates in said wear element.

3. The vacuum gripper of claim 1, further comprising a signal generator connected to said electrically conducting object.

4. The vacuum gripper of claim 3, wherein said signal generator is one of an optical signal generator, a lamp, an acoustic signal generator, and a loudspeaker.

5. The vacuum gripper of claim 1, wherein said conducting object is elastically deformable to a limited extent and breaks or fails after a predetermined number of load changes.

6. The vacuum gripper of claim 1, wherein said vacuum element comprises a proximity switch.

7. The vacuum gripper of claim 1, further comprising level markings disposed on an outer and/or inner surface of said vacuum element proximate said sealing lip.

8. The vacuum gripper of claim 1, wherein said wear element is stepped in height or defines a groove.

9. The vacuum gripper of claim 1, wherein said wear element has a coating of another color.

10. The vacuum gripper of claim 1, wherein said wear element comprises another or a differently colored plastic material and/or said vacuum body is a two-component injection-molded part.

11. The vacuum gripper of claim 1, wherein at least sections of said vacuum element comprise a color element, whose color changes with time, with a number of load changes, or after application of an underpressure.

12. The vacuum gripper of claim 11, wherein said color element is said vacuum element itself or is part of said vacuum element.

13. The vacuum gripper of claim 1, wherein said detecting or displaying means has a channel which terminates in said wear element.

14. The vacuum gripper of claim 13, wherein said channel is open to an outside and comprises an underpressure display.

15. The vacuum gripper of claim 1, further comprising an RFID element or a vacuum sensor integrated in said vacuum element.
